(19) United States
(12) Patent Application Publication
(10) Pub. No.: US 2025/0110859 A1
(43) Pub. Date: Apr. 3, 2025

(54) AUTOMATED TESTING AND DOCUMENTATION SYSTEM FOR IT AND OT CONTROL SYSTEMS

(71) Applicants: Darryl Dwight Brayton, Richland, WA (US); Jonathan Pearson, Richland, WA (US); Nolan R. Wright, Orem, UT (US)

(72) Inventors: Darryl Dwight Brayton, Richland, WA (US); Jonathan Pearson, Richland, WA (US); Nolan R. Wright, Orem, UT (US)

(21) Appl. No.: 18/902,791

(22) Filed: Sep. 30, 2024

Related U.S. Application Data
(60) Provisional application No. 63/585,962, filed on Sep. 28, 2023.

(51) Int. Cl. G06F 11/36

(52) U.S. Cl. CPC G06F 11/3684

(57) ABSTRACT

An automated testing system for industrial control systems, including multiple embodiments. The Flowchart-Driven Automated Testing Tool (FDATT) enables users to create and execute test cases via a graphical interface integrated with control systems for efficient automation. The Spreadsheet Testing approach combines in-memory database unit tests with spreadsheet-like assertions for verifying calculations and updates on Data Transfer Objects (DTOs), promoting clarity and independent calculations. The OT Automated Testing Technologies utilizes SIMCase (a/k/a SIMCube) hardware, SIMSuite software, and the Breakout Board™ for scalable testing of PLCs without modifying native code, supporting functions like Flex Matrix and Tag Ring Out for I/O signal verification. Finally, the Test Data Import and Verification Tool imports input and expected output bit files for PLC logic testing through industrial communication protocols, ensuring accurate logic verification and error detection.

### CROSS-REFERENCE TO RELATED APPLICATION

N/A

### FIELD OF THE DISCLOSURE

The present disclosure relates to systems and methods for automated testing and validation of software applications and industrial control systems. Specifically, it covers innovations in testing technologies for both Information Technology (IT) and Operational Technology (OT) environments. The disclosed system includes tools for flowchart-driven automated test generation, spreadsheet-based testing, and real-time testing of Programmable Logic Controllers (PLCs), Distributed Control Systems (DCS), and Human Machine Interfaces (HMIs). It further addresses automated documentation of test results, integration with communication protocols such as Modbus and Ethernet/IP, and comprehensive testing solutions for ensuring the accuracy, efficiency, and traceability of software and hardware components in various industrial and commercial applications.

### BACKGROUND OF THE DISCLOSURE

The field of testing technologies spans across both Information Technologies (IT) and Operational Technologies (OT). In IT, testing is a critical part of the development process for a wide range of software products, from embedded firmware for Internet of Things (IoT) devices to complex web applications involving front-end interfaces, backend services, and databases for data collection, e-commerce, and other user-centric applications. Testing is essential to ensure these systems function as intended, and while automation has made strides in this domain, many processes still require substantial human involvement. For instance, unit testing or whitebox testing is often automated and integrated into the code to test boundary conditions, error handling, and functionality. However, blackbox testing remains largely dependent on human testers, who manually execute test cases by providing inputs, observing outputs, and comparing them against expected results. This form of testing, which occurs at various stages such as development, pre-acceptance, acceptance, and maintenance, often relies on human oversight to ensure software meets specified criteria, regardless of the development methodology used, such as Waterfall or Agile/Scrum.

In OT, testing technologies are applied in the development of systems such as Programmable Logic Controllers (PLC), Distributed Control Systems (DCS), and Human Machine Interfaces (HMI), which control real-world processes and machinery. Despite advancements, the automation of testing in this sector remains limited. Semi-automated testing processes are common but still require substantial human intervention. Software simulators, for example, can automate certain aspects but often require a human tester to configure the test scenarios and validate responses. Other methods, like the physical re-termination of wiring to inject signals and test alarms or interlocks, involve significant manual labor. Additionally, many OT test results are recorded manually, increasing the likelihood of errors. Like IT, OT testing occurs in various phases including Factory Acceptance Testing (FAT), Construction Acceptance Testing (CAT), and Operational Acceptance Testing (OAT), with ongoing maintenance and regression testing required for updated systems.

### Disadvantages of Current Testing Methods and Practices

In IT: 1) Current manual and semi-automated testing methods can be labor-intensive and costly, often requiring extensive tester involvement. This can lead to inefficiencies, higher project costs, and longer development cycles. 2) Ensuring full test coverage across different types of tests is challenging. For instance, a requirement identified by a specific ID may require multiple test types. Without a pragmatic method to correlate results from various test processes, it can be difficult to ensure that all requirements are thoroughly tested and accepted before code release, increasing the risk of latent defects. 3) Incomplete test coverage or inadequate tracking of testing progress can result in critical issues being discovered later, after the software is in use. In OT, the limitations of current OT testing methods can be categorized into two main areas:
1. Semi-Automated Testing: Semi-automated testing methods in Operational Technology (OT) often prove to be inefficient in terms of cost and scheduling, as they frequently rely on brute-force testing approaches. While PLC software simulators are employed, they typically have a limited scope, conducting only a fraction of the necessary tests. While simulators can test aspects of the system, they only test in software simulation space.

They do not test the actual hardware and the electrical phenomenon, and/or the actual network behavior which can hide many latent defects. Consequently, technicians and engineers are required to supplement these efforts with manual tools. This limitation results in testing that is often confined to a narrow range of logic combinations, rather than utilizing a robust, fully automated method capable of addressing a broader array of test parameters. Moreover, even when a system successfully passes these tests, latent errors can still arise during actual operation, leading to costly re-testing efforts.
2. Manual Testing: The manual nature of many Operational Technology (OT) testing processes results in significant inefficiencies across various aspects, including documentation, repeatability, and project cost management. Tests are frequently created in word processing documents that lack integration with a comprehensive information management system, making it difficult to reproduce, retrieve, and search for tests. Additionally, human errors during signal generation and testing can lead to incorrect data or failed tests, causing project delays of weeks due to the extensive rework required to correct these issues. Moreover, the manual documentation of test results is a tedious process, prone to errors, and presents challenges in organizing information for formal reporting, making it nearly impossible to search for specific issues or test results efficiently. Regression testing on modified systems is also limited, often necessitating the use of live production environments, which introduces risks to both the system and operational schedules.

Both IT and OT testing face similar challenges—inefficiency, high costs, incomplete test coverage, and manual processes prone to errors. The solution lies in adopting new testing technologies that integrate requirements documentation, design, and testing into a cohesive and fully automated testing solution. This approach would ensure comprehensive test coverage, reduce human error, and improve the efficiency and effectiveness of testing processes across both IT and OT environments.

Prior art patents in the field of disclosure that attempt to address some of the issues discussed herein include U.S. Pat. No. 8,291,265, titled Integrated Acceptance Testing; U.S. Pat. No. 7,162,385, titled Control System Simulation, Testing, and Operator Training; U.S. Pat. No. 7,133,794, titled Simulator Cart; U.S. Pat. No. 6,904,380, titled Simulator Cart; U.S. Pat. No. 6,823,280, titled Control System Simulation, Testing, and Operator Training; and Australian Patent No. 767,442, titled SIMCart Automated PLC and HMI Testing, all of which are hereby incorporated by reference to the instant application.

Traditional software development methods involve manually collecting and documenting requirements, generating detailed Software Design Descriptions (SDDs), and manually testing systems. This process can lead to inefficiencies and errors, particularly when dealing with large-scale projects involving multiple stakeholders. The Flowchart-Driven Automated Testing Tool (FDATT) presents an innovative solution by automating both the design and testing processes. Through its flowchart-based interface, FDATT allows users to develop software designs using predefined flowchart components from its library. These flowcharts, once validated for specific input requirements and metadata, are automatically transformed into comprehensive test suites and lifecycle documents, such as Software Requirements Specifications (SRS), SDDs, and Acceptance Test Plans (ATP). Example metadata for each component in the flowchart includes:
Element ID: Serves as a unique identifier for each component in the flowchart.
Element Type: Specifies the type of component (e.g., Input, Button, Condition, Decision, Output, Action).
Input/Output Tag: Corresponds to system variables or tags used in control systems, such as PLC I/O signals.
Condition: Denotes any specific logic or condition that triggers different branches (e.g., if, else, switch-case conditions).
Action/Operation: Specifies what operation or action is associated with the element (e.g., click, submit, read, or write).
Simulation Mode: Indicates the fidelity of simulation (with possible values of Low, Medium, High).
Element Description: Provides a human-readable description of the component's functionality.

The FDATT system is unique in generating tests directly from flowchart-based designs, enabling complete traceability and scenario-based test variations by dynamically adjusting branch paths and metadata variables. These variations are automatically executable in testing frameworks, such as Selenium, ensuring comprehensive test coverage across all possible workflows and input conditions. By automating these traditionally manual processes, FDATT significantly improves efficiency, reduces errors, and provides a robust, traceable method for ensuring software quality and consistency.

Typically, the SRS involves gathering requirements from stakeholders, ensuring they are specific, measurable, achievable, relevant, and time-bound. Once finalized, the SRS is approved by all stakeholders and becomes the basis for design and testing. The SDD, on the other hand, provides detailed descriptions of software components, modules, interfaces, and data flow, and includes diagrams and flowcharts. Upon approval, the SDD becomes the blueprint for development. Lastly, the ATP includes acceptance and system tests based on use case scenarios, boundary conditions, and error conditions, ensuring that the software meets all design and requirement specifications.

These shortcomings in the state of the art can be addressed via the introduction of the following methodologies or tools: the Flowchart-Driven Automated Testing Tool (FDATT); Information and Data Driven Testing utilizing Spreadsheets and/or Databases; OT Automated Testing Technologies; and the Test Data Import and Verification Tool for PLC Logic Testing.

The FDATT introduces a novel approach to software testing for both IT and OT systems. FDATT fundamentally changes the way tests are designed and executed by enabling the automatic generation of comprehensive test suites and lifecycle documents based on a flowchart representation of the software. This automated process results in significant improvements in efficiency, accuracy, and traceability, providing a clear advantage over traditional software testing methods. The FDATT approach transforms the conventional process of testing software by making the flowchart design the core of software development and testing. Users develop a flowchart representing the software architecture using predefined flowchart pieces from the FDATT library.

Flowchart pieces include standardized components such as data input fields, button actions, conditional decision points, form submissions, and navigation commands. These components allow users to visually represent complex software workflows. Unlike traditional software testing tools that generate tests from code, FDATT introduces a novel method by allowing users to generate tests directly from a flowchart-based design, bypassing the need for manual test scripting. In addition to test cases, FDATT automates the generation of essential lifecycle documentation, including Software Design Descriptions (SDD), Software Requirements Specifications (SRS), and Acceptance Test Plans (ATP). This ensures that design, testing, and documentation are all aligned and generated from a single source—the flowchart. This innovative approach allows for:
1. Flowchart-Driven Test Generation: FDATT generates comprehensive test suites and lifecycle documents from a visual flowchart, a method not previously seen in the software testing field.
2. End-to-end Traceability: The ability to link flowchart components directly to requirements ensures complete traceability from design to testing.
3. Automatic Execution Compatibility: Tests generated by FDATT can be automatically executed in widely used frameworks, such as Selenium, making it compatible with existing automated testing infrastructures.
4. Scenario-Based Test Variations: FDATT's ability to generate multiple scenario variations based on flowchart branches ensures that all possible conditions are tested, providing a robust solution for software testing.

These features offer several key advantages over traditional methods, including speed, accuracy, and the ability to generate all relevant documents from a single source—the flowchart.

Tools such as the FDATT improve the art by enabling tests to be defined in flowchart and spreadsheet-like formats and stored in spreadsheets and/or databases. This approach not only streamlines the verification of data objects and automates calculations but also enhances clarity and reduces errors in test design and execution. In the context of Spreadsheet Testing, users can easily define input data, expected outcomes, and test logic in an organized manner, facilitating better collaboration among team members and improving test coverage. This methodology allows for quick modifications and updates, making it adaptable to changes in requirements or data sets.

It should be noted that existing testing methods in OT, such as manual signal injection or semi-automated simulators, are labor-intensive and prone to errors. The introduction of OT Automated Testing Technologies addresses these inefficiencies by integrating a simulation software (SIMSuite), a simulation hardware with embedded software (SIMCase), and the Breakout Board™ to automate testing across a wide range of I/O points without altering native PLC operational code. It includes automated features like the Flex Matrix™ for scalable testing and Tag Ring Out™ for verifying I/O signals and wiring.

Additionally, the Test Data Import and Verification Tool for PLC Logic Testing automates logic validation by importing test data files containing expected inputs and outputs and verifying the actual logic of the PLC through industrial protocols such as Modbus or Ethernet/IP. This tool ensures accurate logic verification while reducing manual intervention and errors in the testing process.

These innovations enhance the accuracy, efficiency, and scalability of both IT and OT testing, addressing challenges such as incomplete test coverage, human errors, and inefficiencies in documentation and tracking. By automating test generation and execution, the system enables seamless testing across Pre-Factory Acceptance Testing, commissioning, and maintenance, offering full traceability and lifecycle management.

### SUMMARY OF THE SUBJECT DISCLOSURE

This subject disclosure relates to an automated testing system for industrial control systems, including multiple embodiments. The Flowchart-Driven Automated Testing Tool (FDATT) enables users to create and execute test cases via a graphical interface integrated with control systems for efficient automation. The Information and Data Driven Testing utilizing Spreadsheets and/or Databases approach combines in-memory database unit tests with spreadsheet-like assertions for verifying calculations and updates on Data Transfer Objects (DTOs), promoting clarity and independent calculations. The OT Automated Testing Technologies utilizes SIMCase hardware, SIMSuite software, and the Breakout Board™ for scalable local testing and/or remote testing of PLCs without modifying native code, supporting functions like Flex Matrix™ and Tag Ring Out™ for I/O signal verification. Finally, the Test Data Import and Verification Tool imports input and expected output bit files for PLC logic testing through industrial communication protocols, ensuring accurate logic verification and error detection. These embodiments collectively enhance testing accuracy, scalability, and efficiency in industrial environments.

### BRIEF DESCRIPTION OF THE DRAWINGS

FIG. 1 shows a flowchart of the FDATT.

FIG. 2 shows a flowchart of the Spreadsheet Testing.

FIG. 3 shows a box diagram of the Breakout Board.

FIG. 4 shows a typical Breakout Board implementation.

FIG. 5 shows an implementation flowchart of the Automap function in SIMSuite.

FIG. 6 shows an example of the Automap function in SIMSuite.

FIG. 7 shows an implementation flowchart of the Load'N'Go automated test.

FIG. 8 shows an implementation flowchart for the Flex Matrix™ automated test.

FIG. 9 shows an example test spreadsheet using the Flex Matrix™ automated test.

FIG. 10 shows an example report from a test run to show pass or fail criteria using the Flex Matrix™ automated test.

FIG. 11 shows an implementation flowchart for the Tag Ring Out automated test.

FIG. 12 shows an example test spreadsheet using the Tag Ring Out automated test.

FIG. 13 shows an implementation flowchart for the Test Runner automated test.

FIG. 14A shows an example test spreadsheet using the Test Runner automated test.

FIG. 14B is a continuation of the example test spreadsheet shown in FIG. 14A.

FIG. 15 shows an example implementation of SIMCase PLC software.

FIG. 16 shows an exemplary embodiment of an execution of the FDATT.

### DETAILED DESCRIPTION OF THE SUBJECT DISCLOSURE

### I. Flowchart-Driven Automated Testing Tool

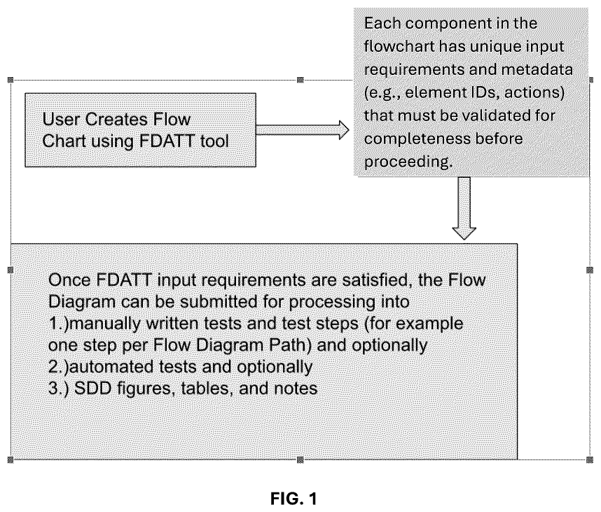

In one embodiment, the present invention relates to an innovative software testing approach called the Flowchart-Driven Automated Testing Tool (FDATT), as shown in FIG. 1. FDATT automates the design, generation, and execution of software tests, enabling faster, more accurate, and comprehensive testing by leveraging flowchart-based software design. This tool not only produces tests but also creates associated Software Design Description (SDD) documents, tables, and traceability matrices, all derived directly from the flowchart. FDATT's capabilities reduce the need for manual testing, significantly improving efficiency, accuracy, and the overall quality of software products.

Traditional software development methods involve collecting requirements, documenting them, and generating detailed software design descriptions (SDD). Testing, often conducted manually, is prone to inefficiencies and errors. FDATT introduces a breakthrough by automating these processes. The tool's core concept is to enable users to develop software designs through a flowchart-based interface. Using standardized flowchart pieces from the FDATT library, users construct flowchart designs that the tool converts into comprehensive sets of tests and supporting documents such as SDDs and ATPs.

As the flowchart is created, FDATT prompts the user to input required data for each flowchart piece, automatically generating tables for the SDD. Each flowchart path represents different execution scenarios, and the tool ensures that every possible path is covered in the generated tests. This includes various scenario variations, ensuring robust testing of all aspects of the software.

The proposed FDATT automates software testing through a unique flowchart-driven approach, which includes the following steps: 1) Develop a Flowchart Design Using Standardized Flowchart Pieces; 2) Generate Tests and Associated Tables for the Software Design Document (SDD); 3) Ensure Comprehensive Test Coverage and Scenario Variations; 4) Generate Automatic Browser-Based Tests and/or HMI; 5) Link Flowchart Paths to Requirements for Traceability; 6) Execute Tests Automatically and Report Results; and 7) Improve Software Quality and Reduce Costs. Below is a description of each step.

1. Develop a Flowchart Design Using Standardized Flowchart Pieces. The user begins by developing a flowchart that represents the software design using FDATT's library of predefined flowchart pieces. Each piece in the library corresponds to a specific function or operation within the software, such as data input, processing, or output. The user can drag and drop these pieces to construct the flowchart, building a visual representation of how the software operates. The tool will prompt the user to input required metadata for each piece, ensuring that all necessary data is captured for the later testing and documentation phases. This step simplifies the design process and ensures that the flowchart is both comprehensive and understandable, offering a clear visual map of the software logic and operations. In view of the foregoing, FDATT automatically generates test cases based on the flowchart design, covering all paths through the software. Each flowchart piece corresponds to a set of tests, ensuring comprehensive coverage of the software's functionality. The tool's predefined flowchart components enable automatic generation of test cases that include extensive scenario variations to thoroughly test every aspect of the software. As the flowchart is built, FDATT collects necessary metadata, which is used to generate test cases, life cycle documents, and scenario variations. This metadata is essential for building a comprehensive and traceable test suite.

2. Generate Tests and Associated Tables for the Software Design Document (SDD). As the flowchart is developed, FDATT automatically generates the associated tables for the Software Design Document (SDD). The tables include detailed information about each piece of the flowchart, such as its function, input/output data, and interaction with other pieces. Additionally, FDATT generates tests based on the flowchart design, ensuring that all paths through the software are covered. The tool integrates lifecycle documentation into this process, including the Software Requirements Specification (SRS) and Acceptance Test Plan (ATP). The flowchart design directly feeds into the documentation, ensuring consistency across all phases of development.

3. Ensure Comprehensive Test Coverage and Scenario Variations. FDATT generates tests that cover all possible paths through the flowchart, ensuring comprehensive test coverage. This includes generating multiple scenario variations to account for different data inputs, conditions, and boundary cases. The rigor of the tests is determined based on the user's input and can range from basic functional tests to more complex edge case scenarios. This step ensures that the software is thoroughly tested, accounting for all potential real-world use cases and conditions that might arise during its operation.

4. Generate Automatic Browser-Based and/or HMI Tests. Once the flowchart and associated tests are generated, FDATT creates automatic browser-based and/or HMI tests using frameworks such as Selenium. These tests can be executed automatically within a browser and/or HMI, simulating real user interactions with the software. FDATT's integration with Selenium allows for seamless execution of these tests in an IT environment, enabling automated validation of web-based applications. This step dramatically speeds up the testing process and reduces the need for manual intervention, ensuring consistent, repeatable test execution.

5. Link Flowchart Paths to Requirements for Traceability. Each piece of the flowchart can be linked back to specific requirements from the Software Requirements Specification (SRS), creating a traceable matrix between the design, the tests, and the requirements. This Requirements Traceability Matrix (RTM) allows stakeholders to ensure that all requirements are tested and that each test step is aligned with a corresponding requirement. This step enhances transparency and traceability, ensuring that the software meets all stakeholder expectations and design specifications.

6. Execute Tests Automatically and Report Results. FDATT allows for the automatic execution of the tests it generates. The tool runs the tests within the appropriate environment, including the automatic browser-based tests, and records the results. Any discrepancies, errors, or failed tests are flagged, and detailed reports are generated for review. This step enables the quick identification of issues, improving the speed of debugging and issue resolution.

7. Improve Software Quality and Reduce Costs. The tool's ability to automatically generate comprehensive lifecycle documentation (SRS, SDD, ATP) reduces the burden on developers. As a result, the overall quality of the software improves, with reduced errors, faster development cycles, and lower costs. This final step underscores FDATT's efficiency and cost-effectiveness, making it an invaluable tool for software development companies.

As such, FDATT offers numerous advantages over existing software testing tools and manual methods. These advantages include:

1. Automation of Testing and Documentation: FDATT automates the creation of tests and lifecycle documents based on the flowchart design, reducing manual effort and improving consistency. This includes the automatic generation of the SRS, SDD, ATP, and RTM, ensuring full traceability across all lifecycle stages.

2. Comprehensive Test Coverage: FDATT ensures that all paths through the flowchart are covered by the generated tests. This includes both normal and exceptional scenarios, ensuring thorough testing of the software under various conditions. Scenario variations cover different input conditions, branch paths, and potential edge cases.

3. Traceability to Requirements: FDATT allows each flowchart component to be linked directly to specific requirements, ensuring that all requirements are covered by the generated tests. The RTM provides stakeholders with clear visibility into the relationship between requirements and tests.

4. Improved Accuracy and Efficiency: By automating the test generation process, FDATT eliminates human errors common in manual testing. Additionally, FDATT's speed in generating tests allows testers to focus on more critical, high-level tasks, accelerating the software development cycle.

5. Cost Reduction: FDATT eliminates the need for extensive manual testing and documentation, resulting in substantial cost savings for software development companies. The automation of lifecycle document generation further contributes to reduced labor costs and faster project completion.

6. Seamless Integration: Tests generated by FDATT are ready for execution in popular automated testing frameworks like Selenium. This enables quick, efficient, and repeatable tests in a browser environment, further improving the speed and reliability of the testing process.

FDATT provides a breakthrough in software testing by automating the generation of comprehensive tests and lifecycle documents directly from a flowchart design. This innovative approach improves efficiency, accuracy, and traceability, reducing costs and improving the overall quality of software. The ability to generate tests and lifecycle documents from a flowchart, rather than from code, sets FDATT apart as a novel and patentable invention with the potential to significantly impact the software testing industry.

In sum, FDATT represents a shift in software development and testing. By automating test generation, execution, and documentation from a flowchart-based design, FDATT saves time, reduces errors, and improves overall software quality. The tool's ability to provide complete traceability between requirements and test results enhances transparency and ensures comprehensive coverage, making it a powerful asset for modern software development. As such, FDATT's novel approach and the benefits it provides address longstanding inefficiencies in the software testing field.

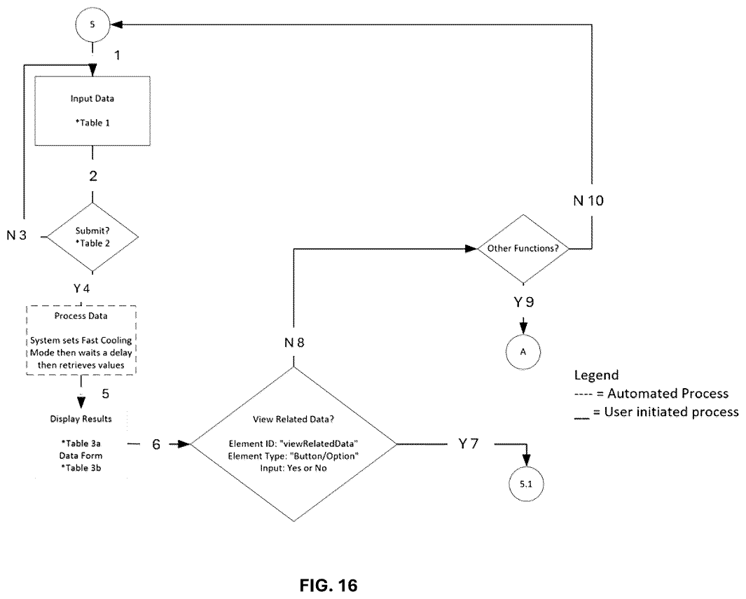

FIG. 16 shows an exemplary embodiment of the execution of the FDATT. Once the process flow diagram is entered into a graphical format with metadata templates and associated input/output data results in tables are created, a user may generate the test case containers automatically. The test case containers will have metadata that may be joined to a common test case name, but this assures that the entire range of the process flow chart is tested, including all data inputs in the test steps generated. For example, referring to FIG. 16, the following four test case containers will be generated, that will contain the test steps are named as follows:
1. The common name is Test Case 1: 5,1,2,4,5,6,7,5.1
2. The common name is Test Case 2: 5,1,2,3,1,2,4
3. The common name is Test Case 3: 5,1,2,4,5,6,8,9,
4. The common name is Test Case 4: 5,1,2,4,5,6,8,10,5

These test cases will be populated with a series of test steps generated as necessary to the tables defined for the process diagram for each defined operation in the branching and test the range of use and any error conditions and/or boundary conditions related to the tables defined for the process flow diagram. In the case of expanded testing, you would supplement the test case name and branching with an indicator of “R”, “E”, “B” and the number of tests would triple during generation. Otherwise, it would be assumed to be a non-supplemented range of use. Only process and decision blocks are displayed but data stores and special case processes are also allowed.

Table 1 in FIG. 16 Metadata Form for each process symbol

| | |
|---|---|
| 1. | Input Data |
| 2. | Element ID: “inputTempSensor” |

| | |
|---|---|
| a. | Element Type: “Input Field” |
| b. | InputTag: “DESIRED_TEMP_SENSOR_001” |

| | |
|---|---|
| 3. | InputType: “Number” |

| | |
|---|---|
| a. | Value Range: 50 - 150 |

| | |
|---|---|
| 4. | SetFastCoolingMode = “Y” \| |

| | |
|---|---|
| a. | Element ID: “inputCoolingMode” |
| b. | InputTag: “SetFastCoolingMode” |
| c. | InputType: “Checkbox” |
| d. | Default value Y |

| | |
|---|---|
| 5. | Wait Time: “3 minutes” |

| | |
|---|---|
| a. | Element ID: “inputWaitTime” |
| b. | InputTag: “WaitTime” |
| c. | InputType: “Number” |
| d. | Default Value 3 minutes |

| | |
|---|---|
| 6. | Temperature Tag For Area |

| | |
|---|---|
| a. | Element Type: “Input Field” |
| b. | InputTag: “CURRENT_AREA_TEMP_SENSOR_001” |

| | |
|---|---|
| 7. | Enter Acceptance Criteria (value 50-150) |

Table 2 in FIG. 16 Metadata form for decision box

| | |
|---|---|
| 1. | Submit Button |

| | |
|---|---|
| a. | Element ID: ″submitButton″ |
| b. | Element Type: ″Button″ |
| c. | Action: Submit Form |

| | |
|---|---|
| 2. | Cancel Button |

| | |
|---|---|
| a. | Element ID: “cancelButton” |
| b. | Element Type: “Button” |
| c. | Action: Cancel and clear fields |
| d. | Reference needed to all field ID's to be cleared |

| | |
|---|---|
| 3. | Enter Acceptance Criteria (Submit or Cancel selected) |

Table 3a in FIG. 16 Metadata form for display process

| | |
|---|---|
| 1. | Display Desired Temperature: (Show desired input temperature) |
| 2. | Initial Temperature: (Show temp For Area before setting fast cooling mode) |
| 3. | Temperature after 3 minutes: (Show new temperature value For Area) |
| 4. | Show Fast Cool Mode Status: (Show if active) |
| 5. | Initiate deadband and check before clearing alarms. |
| 6. | Enter Acceptance Criteria data displayed as per table 3b, with three minute (as per input |
| | in table 1) update delay after initial. |

Table 3b in FIG. 16 Data Table for display process

| | |
|---|---|
| 1. | Display Temperature Range as 0.00 to 100.00 |
| 2. | Display Temperature above 95 as Red |
| 3. | Display Temperature below 10 as yellow |
| 4. | Display Temperature below 5 as Red |
| 5. | All fonts per standard as defined in data table 52 Note to reader: This will chain test |
| | steps and/or test requirements from another table into this set of test steps. This |
| | process can be used on any table type to supplement data from a previously defined |
| | system, process flow diagram, process flow tables, and/or metadata or test sets. |

The exemplary embodiment above would be repeated until all tests related to the branch path are completed.

### Test 1: Fast Cooling Mode=Yes (Submit “Yes” After Input)

Branch Paths 5,1,2,4,5,6,7

### Metadata:

Desired Temperature Input: 90 (within range)
Current Area Temperature Input: 95 (within range).
FastCoolingMode: Y

### Test Steps:

1. Input Data (see table 1):
   Enter Desired Temperature as 90 (Element ID: input1).
   Enter Current Area Temperature as 95 (Element ID: input2).
   Set FastCoolingMode to Y (Element ID: submit1).
2. Submit (see table 2):
   Click Submit (Element ID: submit1).
3. Process Data:
   System sets Fast Cooling Mode and waits 3 minutes (Element ID: process1).
4. Display Results (see tables 3a and 3b):
   Display initial temperature (95), final temperature after 3 minutes, fast cooling status as Active, and any alarms.
5. Verify Results Match Expected Criteria from metadata form comparison.
6. Decision (View Related Data):
   Select “Yes” to view related data (Element ID: viewRelatedData).
7. Proceed to Module 5.1.

### Expected Outcome:

Fast cooling mode is activated.
Temperature changes within the 3-minute wait period.
Related data is displayed successfully.
   Test 2: Fast Cooling Mode=No (Same Branch Paths as Test 1 with Different Metadata Values)
Branch Paths 5,1,2,4,5,6,7

### Metadata:

Desired Temperature Input: 85 (within range)
Current Area Temperature Input: 80 (within range)
FastCoolingMode: N

### Test Steps:

1. Input Data (see table 1):
   Enter Desired Temperature as 90 (Element ID: input1).
   Enter Current Area Temperature as 95 (Element ID: input2).
   Set FastCoolingMode to Y (Element ID: submit1).
2. Submit (see table 2):
   Click Submit (Element ID: submit1).
3. Process Data:
   System sets Fast Cooling Mode and waits 3 minutes (Element ID: process1).
4. Display Results (see tables 3a and 3b):
   Display initial temperature (95), final temperature after 3 minutes, fast cooling status as Active, and any alarms.
5. Verify Results Match Expected Criteria from metadata form comparison.
6. Decision (View Related Data):
   Select “Yes” to view related data (Element ID: viewRelatedData).
7. Proceed to Module 5.1.

### Test 3: Fast Cooling Mode=No (Different Branch Paths as Test 2)

Branch Paths 5,1,2,3

### Test Steps:

1. Input Data (see table 1):
   Enter Desired Temperature as 90 (Element ID: input1).
   Enter Current Area Temperature as 95 (Element ID: input2).
   Set FastCoolingMode to Y (Element ID: submit1).
2. Do Not Click Submit, click Cancel button (see table 2).

### II. Spreadsheet and/or Database Testing

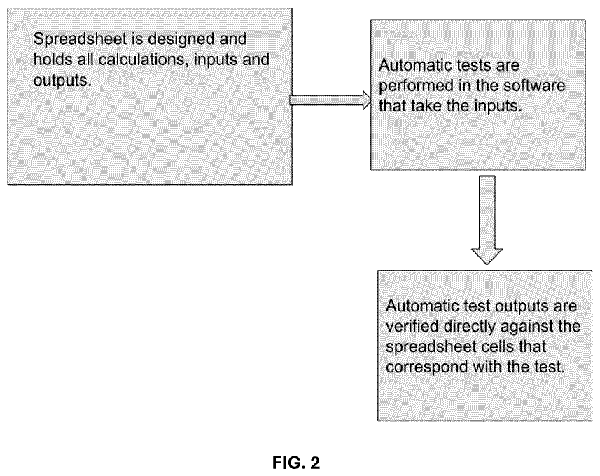

Another embodiment of the subject disclosure relates to a method for performing integration testing of software applications, specifically through an innovative technique referred to as Information and Data Driven Testing utilizing Spreadsheets and/or Databases (hereinafter, Spreadsheet and/or Database Testing), as shown in FIG. 2. This technique allows for the validation of calculations and updates performed on Data Transfer Objects (DTOs) or models by integrating in-memory database unit tests with spreadsheet-like assertions. This novel testing method ensures the accuracy and reliability of complex calculations while providing clear traceability and verification of results.

Spreadsheet and/or Database Testing utilizes an in-memory database unit test to simulate real-world calculations and updates applied to a DTO or model, allowing for comprehensive integration testing. The uniqueness of this approach lies in embedding the spreadsheet alongside the test code, which serves as a matrix of assertions, akin to traditional spreadsheet cells. Each cell contains expected values corresponding to specific calculations or updates in the software system under test (SUT). This layout not only improves clarity but also makes it easier for testers and reviewers to understand and verify the test results.
1. Step 1—In-Memory Database Setup for DTO/Model Testing: The first step involves creating an in-memory database unit test that performs a series of calculations or updates on a DTO or model. The in-memory nature of the database ensures that calculations can be carried out quickly without external dependencies, thus simulating a realistic test environment that mimics actual application behavior. The DTO or model can represent any logical unit of data within the software system, including data structures used in business logic, transactional information, or any other relevant software artifact.
2. Step 2—Spreadsheet-Like Assertions: Simultaneously, a spreadsheet-like structure is defined in code. This structure represents the assertions or expected results for each calculation or update applied to the DTO or model. The spreadsheet organizes these assertions in a format similar to cells in a traditional spreadsheet, where each row corresponds to a test case, and each column represents a particular step or expected result of the test. Each assertion in the spreadsheet links directly to a specific calculation performed in the in-memory database unit test, and the expected result is stored in the corresponding cell. This ensures a clear mapping between the test logic and the assertions, promoting ease of understanding and verification.
3. Step 3—Execution and Parallel Test Cases: During the execution phase, the system performs calculations and updates on the DTO/model as per the in-memory database unit test. The actual results of these operations are then compared to the expected results stored in the spreadsheet-like structure. The testing framework can execute multiple test cases in parallel, ensuring that each test case is independent and does not interfere with others. This modular approach facilitates easier maintenance and scalability of test suites, as new test cases can be added or existing ones modified without impacting other tests.
4. Step 4—Results Comparison and Reporting: Once the tests have been executed, the system compares the actual results against the predefined expected results from the spreadsheet-like structure. Any discrepancies or mismatches between the actual and expected results are automatically flagged, with the system generating detailed logs or reports highlighting the failed tests. These reports provide precise information about which calculations or updates failed, along with their respective test steps, to assist in efficient debugging and issue resolution. Additionally, the results comparison is highly transparent, as the spreadsheet-like structure presents a clear, traceable matrix of test steps and results, enabling reviewers to quickly verify the outcomes and trace any errors back to specific steps in the software code.

The advantages of Spreadsheet Testing include the following:
1. Clarity and Readability: Embedding the spreadsheet alongside the test code enhances the clarity and readability of the tests. Reviewers can easily follow the test logic by examining the spreadsheet-like structure, allowing them to identify how each calculation corresponds to the expected results. This reduces ambiguity and increases transparency in the testing process.
2. Comprehensive Integration Testing: By leveraging an in-memory database unit test, Spreadsheet Testing ensures that the calculations and updates applied to DTOs/models are tested within a realistic, controlled environment. This setup allows for comprehensive integration testing that reflects real-world usage scenarios, ensuring the robustness and reliability of the software system.
3. Independent Parallel Calculations: Each test case in Spreadsheet Testing can be run independently of others, allowing for parallel execution without conflicts. This modular approach enables independent calculations and testing of individual functionalities, promoting better scalability and easier troubleshooting.
4. Traceability and Verification: Spreadsheet Testing provides a clear mechanism for tracing each test step and assertion back to specific spreadsheet cells. This traceability ensures that each calculation is validated against its expected result, making it easier to verify the correctness of the software and identify where issues may arise.
5. Reduced Maintenance and Debugging Time: The clear association between test logic and spreadsheet assertions simplifies the process of identifying and fixing errors. If a test fails, developers can immediately pinpoint the corresponding step in the spreadsheet where the failure occurred, reducing the time required for debugging and maintenance.

To further illustrate the Spreadsheet Testing embodiment, consider the following example:

A business application requires calculations related to tax adjustments on sales transactions. A DTO is designed to handle the input of transaction details, and an in-memory database is created to simulate the transactions and store the tax adjustment calculations. In Spreadsheet Testing, the assertions for the expected tax adjustments are embedded in a spreadsheet-like format, where each cell contains the expected value for specific transaction cases (e.g., different tax rates, discount conditions, etc.). The system performs the calculations on the DTO within the in-memory database, compares the actual tax adjustments to the values in the spreadsheet, and generates a report indicating any mismatches. If, for example, a particular transaction resulted in an incorrect tax adjustment, the failure would be logged in the report along with the corresponding step in the spreadsheet, allowing developers to quickly diagnose and fix the issue.

In sum, Spreadsheet Testing presents an innovative method of performing integration tests for software applications. By combining an in-memory database unit test with spreadsheet-like assertions, this approach enhances the clarity, traceability, and overall efficiency of the testing process. It enables independent parallel calculations, ensures comprehensive testing, and reduces maintenance and debugging efforts. The flexibility and transparency of Spreadsheet Testing make it a valuable tool for improving the quality and reliability of software applications, offering a substantial improvement over traditional testing methods.

### III. OT Automated Testing Technologies

Another aspect of the invention relates to OT Automated Testing Technologies, which is a sophisticated system for testing operational technology (OT) components through a combination of hardware and software solutions. This system is designed to efficiently test and simulate real-world conditions without modifying the underlying control logic of the systems under test SUT, ensuring seamless integration and verification in industrial settings such as Programmable Logic Controllers (PLCs) and Distributed Control Systems (DCSs). The core of the system includes the SIMCase (a/k/a SIMCube, SIMCart, etc.) hardware and the SIMSuite software, which together provide an automated, scalable testing solution.

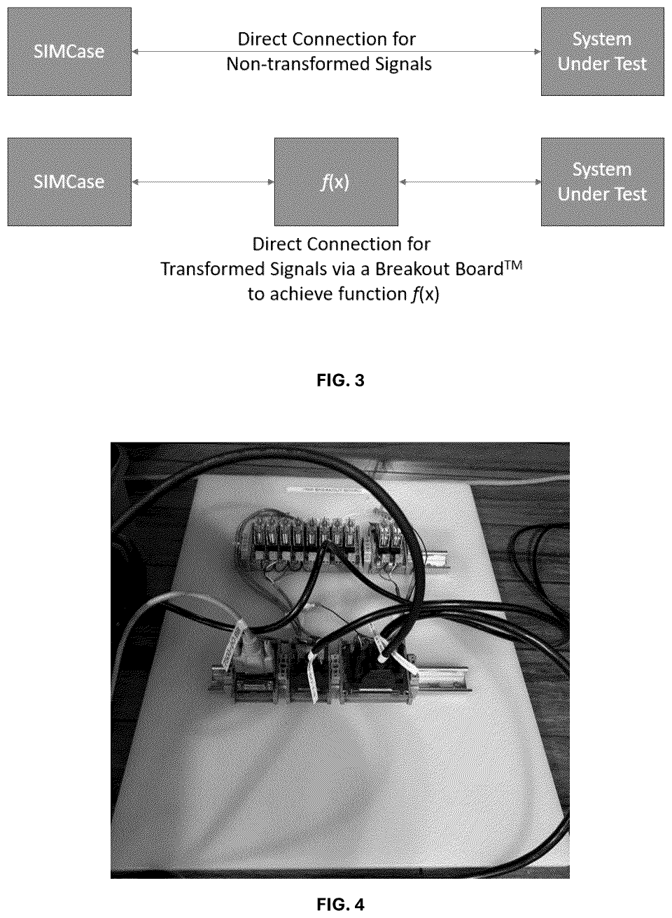

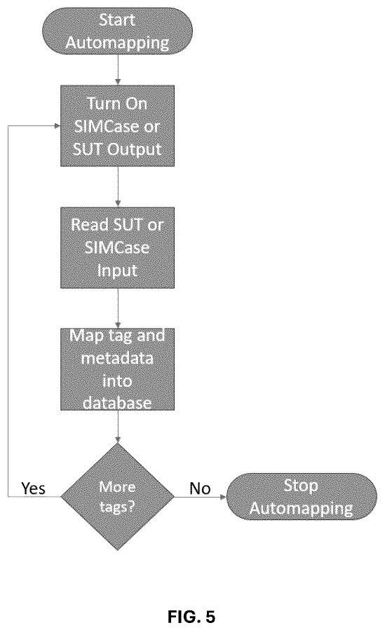

SIMCase Hardware: The SIMCase is a configurable hardware unit that comprises: a network switch; an industrial controller; zero to many discrete inputs and outputs (digital/analog); specialized modules such as thermocouples, RTDs, and pressure transducers; and custom or standard cabling that interfaces directly with the SUT. To a person versed in the state of the art, it is anticipated that other module and/or input/output types may be accommodated in the future. The concept is to configure these in a way that can be networked together to scale the system and increase capacity. SIMCase uses custom or standard cabling to connect to the SUT, however, if specialized transfer functions of the signals are required, this disclosure introduces a Breakout Board™ which uses commercially available components assembled to provide that transfer function to the electrical signals as shown in FIGS. 3 and 4.

SIMSuite Software: The SIMSuite software handles all test creation, execution, and analysis. Its primary functions include:
1. Automap Function: Automatically queries PLC/DCS tag maps to create as-built test setups, allowing users to generate test cases without knowing the precise test environment and/or PLC/DCS hardware configuration.
2. Flex Matrix™ Automated Testing: Generates and executes test cases with flexible pass/fail criteria for digital/analog outputs and inputs, based on a spreadsheet-like structure.
3. Tag Ring Out™: An automated function that verifies wiring, signal polarity, and analog tolerances for I/O channels without the need for manual tools.
4. Test Runner™: A configurable test execution tool that supports fully automated, semi-automated, and manual test modes. It should be appreciated that FDATT can be included as a primary function as well in the SIMSuite Software, and/or as a sub-function within the primary function Test Runner.

The SIMCase allows for flexible configuration by connecting to the SUT via a Breakout Board™, which enables signal processing or transformations as needed (e.g., 120VAC signals, high current signals). The breakout board serves as an intermediary for specialized transfer functions, including full signal simulations powered by artificial intelligence for faster, more realistic responses. Remote access is provided through a Virtual Private Network (VPN) to remote SUT components and modules also, where the electrical phenomenon is gathered remotely and sent over the Internet VPN to the SIMCase/SIMCube, or in some cases directly to the SIMSuite software database or a combination of both.

### SIMCase and SIMSuite Functions:

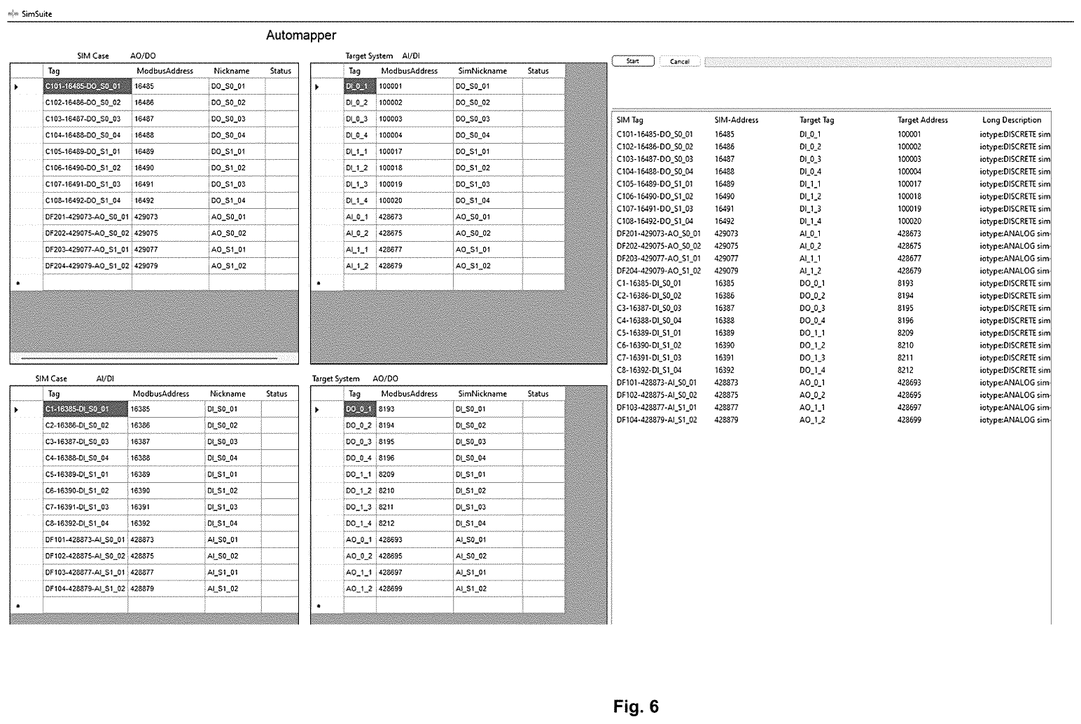

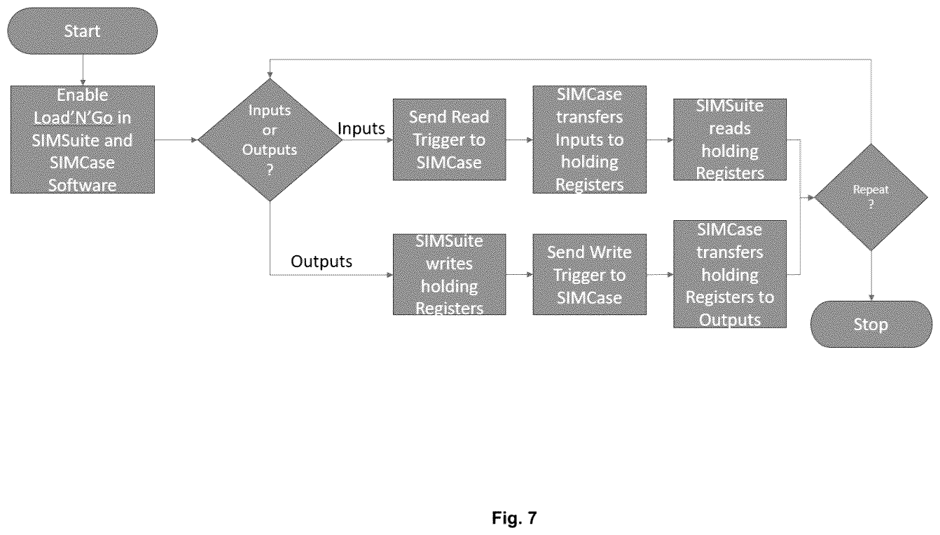

Automap Function in SIMSuite: The Automap feature queries the SUT's tag map, extracting metadata to automatically configure the test environment. This feature guarantees a “mirror” setup, ensuring all I/O channels, tags, and related metadata are captured for testing. This results in faster test case writing, validation, and execution without affecting the SUT's operation. FIG. 5 shows an implementation flowchart of the Automap Function in SIMSuite and FIG. 6 shows an example of the Automap function in SIMSuite.

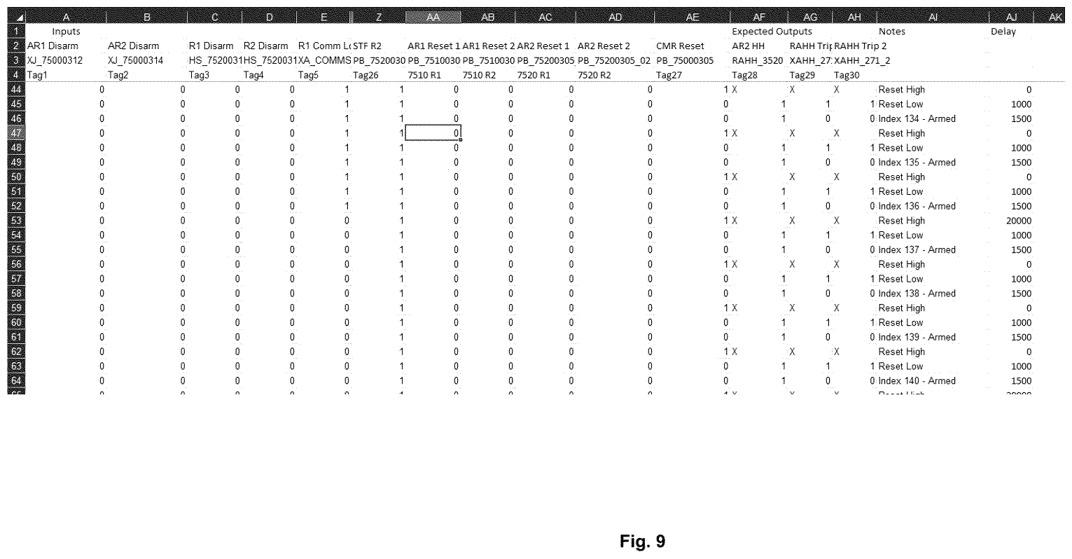

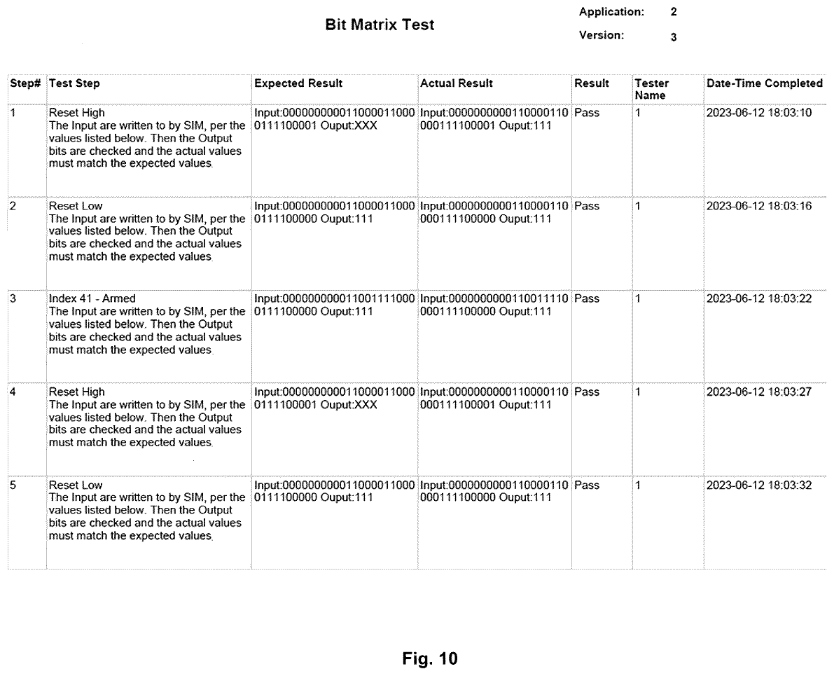

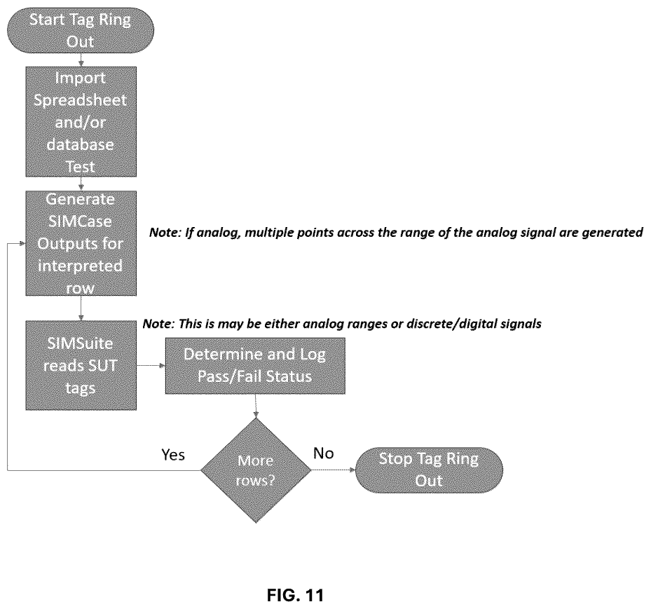

Flex Matrix™ Automated Testing: The Flex Matrix™ function allows for versatile test setups by using a spreadsheet (e.g., Excel) to input all necessary test conditions, expected outputs, and pass/fail criteria. Users can define discrete, digital, and analog I/O, along with programmable delays and test conditions. This structured approach enables the execution of complex test cases and simplifies test result evaluation. The Flex Matrix™ function is shown in FIG. 8. The Flex Matrix™ function is implemented as a SIMSuite software function. The purpose is to create a flexible automated test that can write discreet/digital and analog outputs, PLC tags, read discreet/digital and analog inputs, PLC tags, and automatically determine the pass/fail status of each test case. FIG. 9 shows an example test spreadsheet using the Flex Matrix™ automated test and FIG. 10 shows an example report from a test run to show pass or fail criteria using the Flex Matrix™ automated test.

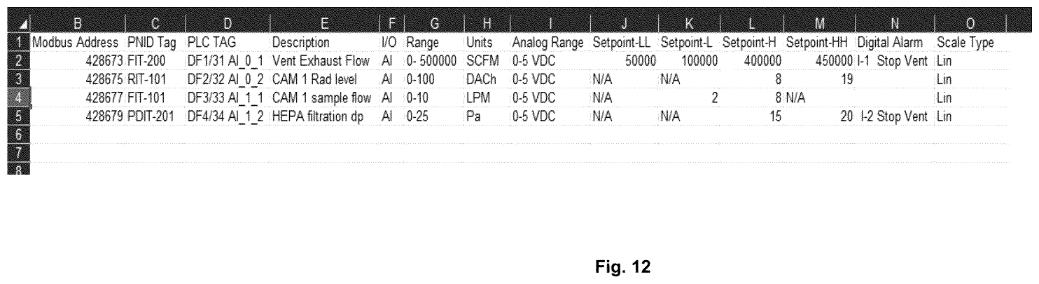

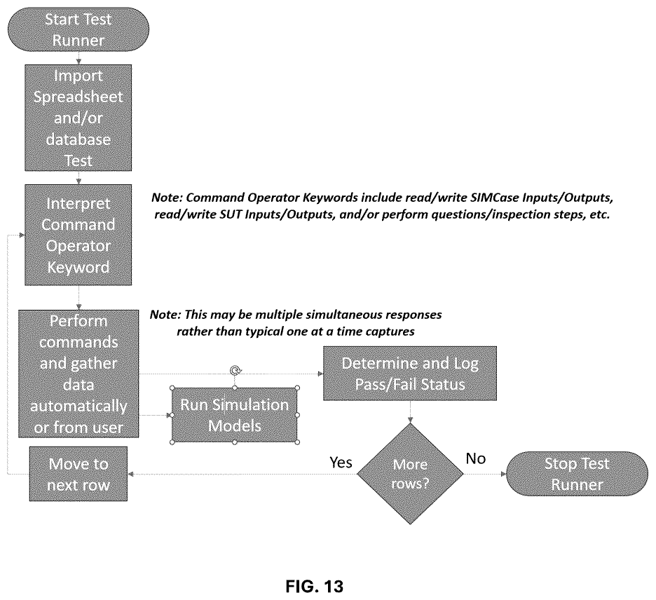

Tag Ring Out™: The Tag Ring Out™ function checks for continuity and correctness in wiring and I/O signals. It automatically reads and writes values to the SUT's I/O channels, verifying polarity and signal ranges without requiring manual intervention. This capability speeds up the testing process while minimizing the risk of human error. An implementation flowchart for the Tag Ring Out™ function is shown in FIG. 11. Tag Ring Out™ is implemented as a SIMSuite software function. The purpose is to create an automated test that can read and write all discrete/digital and analog inputs and outputs of the SUT to check for wiring, signal polarity, and analog ranging and tolerances without additional multimeter tools or landing and lifting leads which has the possibility of compromising connections or damaging equipment. This is implemented using a row-based spreadsheet, such as Excel, to capture all the test conditions and required pass/fail criteria, as shown in FIG. 12.

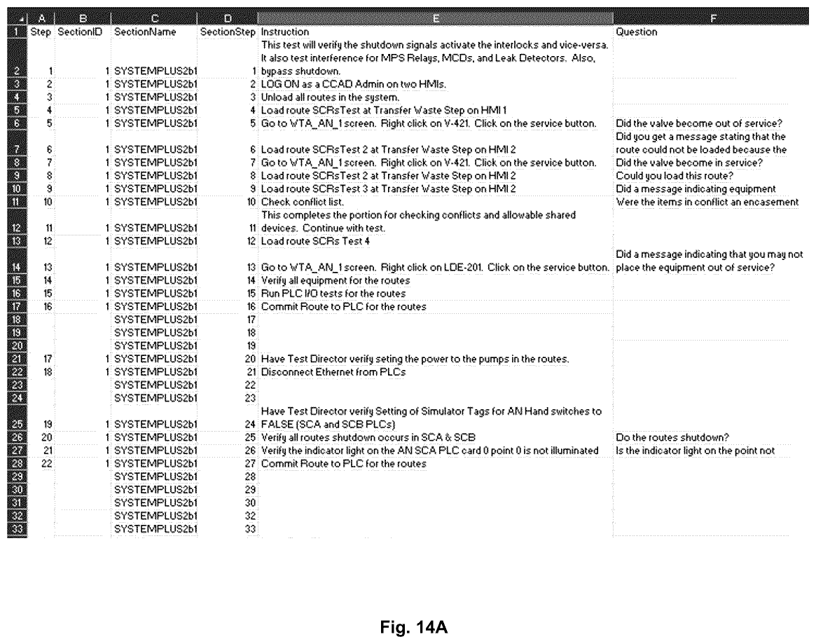

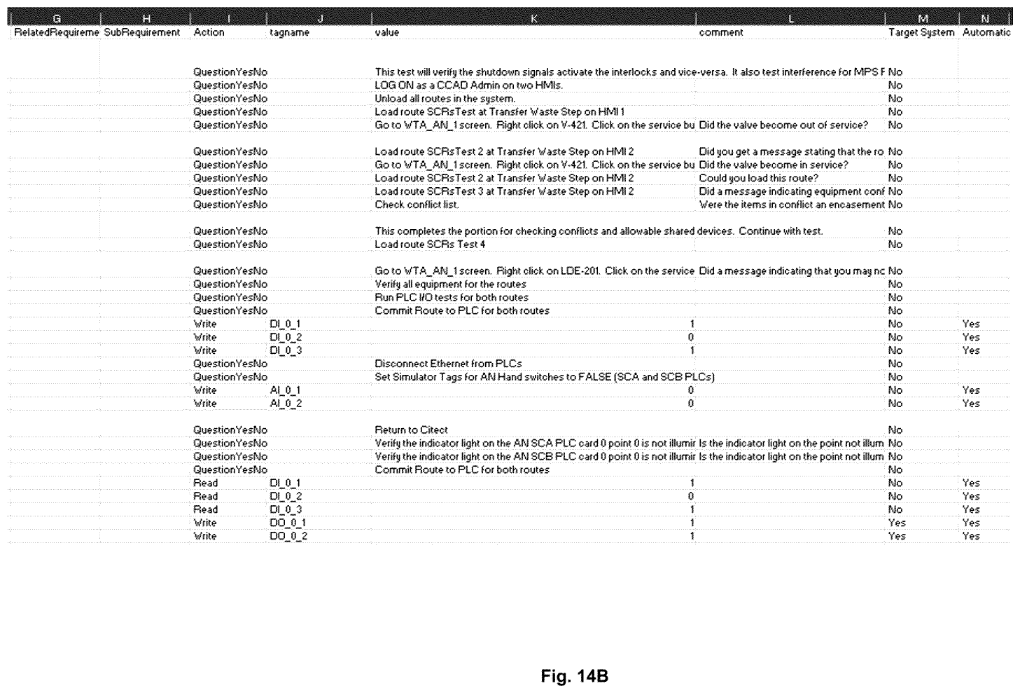

Test Runner™ Modes: Test Runner™ is capable of running in three modes: 1) Manual: Fully controlled by the user, for components that require visual inspection or manual input. 2) Semi-Automated: The system prompts users to perform checks (e.g., setpoint alarms) while automating other parts of the test. 3) Fully Automated: Executes test cases end-to-end with and/or without human intervention, analyzing the results based on pre-programmed criteria. Test Runner™ is configurable by data in the test case to be run in fully manual, semi-automated, fully automatic modes by interpreting a set of keywords in an imported test case spreadsheet that tells the SIMSuite engine whether to read/write SIMCase inputs/outputs, read/write SUT Inputs/Outputs, and/or perform questions/inspection steps. It should be noted that by expanding the library of types of keywords that are interpreted as command operators, new functions may be introduced in the feature utilizing this method. It should also be noted that any of the testing modes can launch low, medium and/or high fidelity emulation and/or simulation models that provide input and process output. For example, motorized valves need time to close, and a simulation would not feedback a closure signal to the SUT until a time variable had been met. This is a low and/or medium fidelity model. A high-fidelity simulation model example would be a set of differential equations modeling temperatures in a yogurt factory in a tank that was being stirred and the stirring variable would input and temperatures through the mixture would feedback from the model. It should further be noted that the user can place metadata in the spreadsheet for tie to other system documents such as requirements, sub-requirements, and design to link these together in a Requirements Traceability Matrix that is utilized as a quality record used for system acceptance. It should also be appreciated that fail results when compared to acceptance criteria, can be logged and communicated to trouble ticket systems, such as Azure Dev Ops for further issue identification, tracking, resolution, and retesting. Thus, resulting in more efficient software lifecycle project management. An implementation of the Test Runner™ function is depicted in the flowchart in FIG. 13. FIGS. 14A-B, on the other hand, show an example test spreadsheet using the Test Runner automated test.

Breakout Board™: The Breakout Board™ is a key hardware innovation that enables customization of signal transfer functions. It supports a wide range of field instrumentation, from thermocouples and transducers to relays and high-voltage/current signals. The Breakout Board™ also allows for AI-based simulation, creating realistic signal responses for comprehensive testing. The Breakout Board™ can be implemented to achieve many different functions from typical inputs and outputs such as 120VAC signals, high current signals, interposing relays, Thermocouple, RTDs, air pressure, and transducers, which are well-known implementations of signals in the field of instrumentation and controls. It is also envisioned that signal processors could put full simulations on the breakout board with Artificial Intelligence or simulations to provide rapid realistic responses. The breakout board could also be implemented remotely over IP at just a target system, rather than at both ends. In this scenario, the remote breakout board would input and/or output data to a target system, but simply be in communication directly with SIMSuite and/or SIMCase via a data highway over TCP/IP (e.g., ModBus) rather than requiring a conversion to electrical phenomenon at the physical SIMCase (a/k/a SIMCube) side of the VPN. In this way, you can accommodate larger numbers of I/O without doubling the cost of having conversion to IP and deconversion to electrical signals and go straight to usable data and information via this alternative method. This breakout board method could also be used in a local implementation.

SIMCase Plug-and-Test System: SIMCase can be connected directly to field devices for ring-out tests or data recording, allowing the SUT to remain connected while diagnosing field equipment (e.g., valves, motors, sensors). This feature enables both online and offline testing modes, providing flexibility in real-world commissioning and diagnostic tasks. The SUT can be disconnected, allowing the SIMCase to be connected in order to run SIMSuite software for ringing out and testing actual field components, whether input or output related (e.g., valves, motors, instruments, sensors, thermocouples, etc.). The connectors are designed to be placed where the SUT is connected to the field I/O. Alternatively, the SIMCase can remain connected alongside the SUT and be used as a data recording device for diagnostics, or for building and replaying simulation cases.

Cloud-Based and Networked Systems: The SIMSuite and SIMCase system can interconnect over a secure VPN, enabling distributed testing across various locations (e.g., different rooms, facilities, or even across state lines). This cloud-based integration allows for collaborative testing, remote diagnostics, and multi-site system verification.

Modular Design of SIMSuite: SIMSuite is designed to be modular and can adapt to the availability of hardware. Whether in the field with hardware, offsite without hardware, or in a mixed scenario, the software smartly adjusts available testing options based on system configuration.

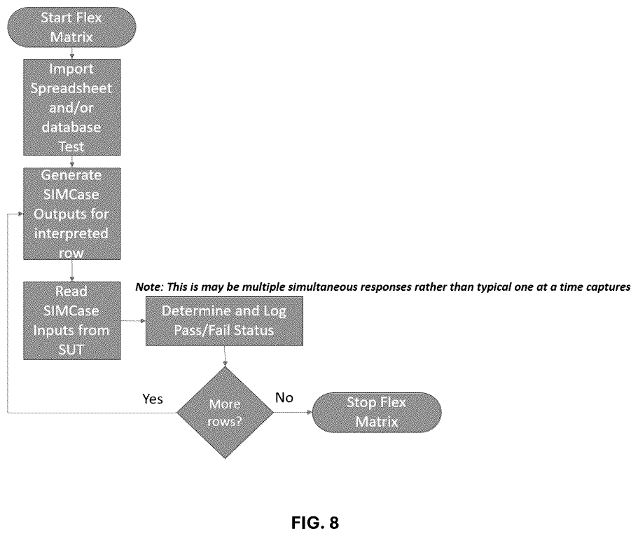

Load'N'Go Mode: This mode synchronizes inputs and outputs between SIMCase and SIMSuite, allowing real-time testing and simulation of control logic. Load'N'Go ensures consistent data reads/writes and asynchronous data exchange, improving test accuracy. A flowchart for the Load'N'Go Mode is shown in FIG. 7.

Test Coverage Analysis and AI-Driven Testing: SIMSuite includes advanced features such as test coverage analysis tools and AI-based learning algorithms to optimize test scenarios. These tools ensure thorough verification and enhance test coverage, detecting anomalies and errors early in the software lifecycle.

SIMCase and SIMSuite are preferably adapted for use in the following cases:

Software Verification & Validation (V&V): SIMCase and SIMSuite streamline the V&V process for PLC/DCS systems, allowing early bug detection and system validation.

Training and Upset Simulations: Operators can use the system for procedural training, simulating real-world upsets for preparedness.

Automated Regression Testing: The system can automate regression testing, validating software changes without disrupting operations.

Field Diagnostics and Commissioning: SIMCase's real-time data recording capabilities aid in early commissioning and diagnostic tasks for field devices.

In sum, the OT Automated Testing Technologies provides a comprehensive, scalable testing solution that integrates real-world operational hardware with advanced testing automation. By leveraging commercial hardware components and proprietary software solutions like SIMCase and SIMSuite, the system ensures accurate, efficient, and flexible testing of industrial control systems. The inclusion of features such as Flex Matrix™, Tag Ring Out™, and Test Runner™ further enhances its utility, making it a valuable tool for industries requiring high reliability and precision in testing their operational technology.

### IV. Test Data Import and Verification Tool for PLC Logic Testing

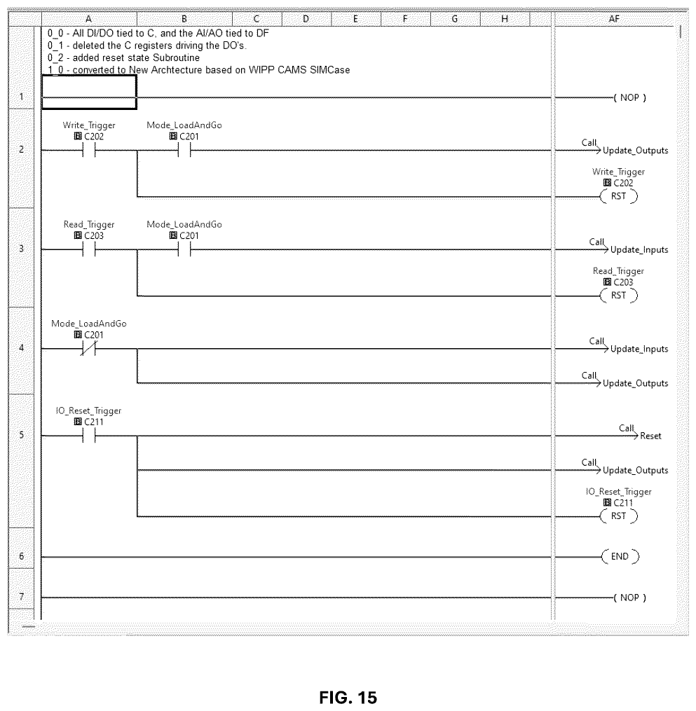

Another aspect of the subject disclosure introduces the Test Data Import and Verification Tool, a comprehensive solution designed to automate the testing and verification of Programmable Logic Controllers (PLCs). This tool enables the import of test data files containing input and output tag values and uses industrial communication protocols such as Modbus or Ethernet over IP to interface with the SIMSuite system, which connects to the SUT. The tool's primary goal is to verify the logic within PLCs by comparing actual output tag values from the SUT with the expected outputs defined in the test data file. FIG. 15 shows an example implementation of SIMCase PLC software.

Key components and features of the Test Data Import and Verification Tool include:
1. Test Data Import: The tool allows users to import test data files containing various input tag values and their corresponding expected output tag values. This provides flexibility in the design of test cases, enabling users to test a wide range of PLC logic scenarios efficiently.
2. Protocol Integration: The tool is integrated with widely used industrial communication protocols such as Modbus and Ethernet over IP, which enable seamless communication between the SimSuite system and the target PLC. These protocols write input/output tags (as bits, and/or bytes, and/or words, and/or data, alone and/or in combination, etc.) to the SUT and retrieve the actual output tag value for verification.
3. Logic Verification: The core function of the tool is to compare the actual output tag values from the PLC against the expected output tag values specified in the imported test data file. Any discrepancies are flagged as potential logic errors, providing immediate insight into the correctness of the PLC logic.
4. Efficiency and Accuracy: By automating the process of writing inputs and verifying outputs, the tool minimizes manual errors and ensures accuracy. This automation saves significant time, particularly in large-scale testing environments, by eliminating the need for repetitive manual testing procedures.
5. Extensibility and Scalability: The tool is designed to be extensible, accommodating various PLC models and configurations. It is easily adaptable to incorporate additional communication protocols, allowing it to be used in different industrial environments with varied testing needs. Its scalable architecture allows for testing small systems or expanding to thousands of I/O points.

Key details of the Test Data Import and Verification Tool include:
1. Test Data Import: The tool simplifies test setup by allowing users to import a test data file containing input and expected output tag values. These files can be structured as spreadsheets or other standard formats, offering flexibility in designing and managing test cases for different PLC logic configurations. Users can create or modify these test files to suit specific testing needs.
2. Protocol Integration with SimSuite: Once the test data is imported, the tool establishes a communication link with the SimSuite system through Modbus or Ethernet over IP protocols. SimSuite, acting as the intermediary, sends input bit data to the SUT, ensuring that the input conditions specified in the test file are correctly written to the PLC. The tool then retrieves the output tag values generated by the PLC in response to the input conditions.
3. Logic Verification Process: After retrieving the actual output tag values from the SUT, the tool automatically compares them against the expected output tag values outlined in the imported test file. Any discrepancies between actual and expected outputs are flagged as potential errors, allowing for the identification of faults in the PLC's logic. This verification process is key in assessing the performance of PLC code under different input conditions.
4. Automation for Enhanced Efficiency: By automating the entire testing process-from the importation of test data to the verification of logic-the tool significantly improves efficiency. The elimination of manual testing procedures not only saves time but also reduces the likelihood of human error, making it especially useful for large-scale systems with extensive I/O points.
5. Error Detection and Reporting: The tool includes a robust reporting mechanism that logs any identified discrepancies between actual and expected output tag values. Reports can be generated in various formats, allowing testers and engineers to easily review the results, track the source of errors, and implement necessary corrections.

Steps involved in the testing process when using the Test Data Import and Verification Tool:
1. Import Test Data File:
   Load a file containing input tag values and expected output tag values into the tool.
2. Establish Communication:
   The tool connects to the SimSuite system using Modbus or Ethernet over IP protocols.
3. Send Input Tag Values:
   The tool writes the input tag values from the test data file to the SUT via SimSuite.
4. Retrieve Output Tag Values:
   The tool retrieves the actual output tag values generated by the SUT in response to the input tag values.
5. Compare Outputs:
   The tool compares the actual output tag values with the expected output tag values specified in the test file.
6. Error Flagging:
   Any discrepancies between the actual and expected outputs are flagged as potential logic errors.
7. Generate Reports:
   Reports or logs are created, detailing the test results, detected logic errors, and any discrepancies.

Advantages of the Test Data Import and Verification Tool:
1. Pre-FAT Development Testing:
   The tool allows for pre-Factory Acceptance Testing (FAT) development, enabling early identification of logic errors before the system is physically constructed. This emulation of field conditions accelerates testing, reducing project timelines and costs.
   Comprehensive test writing capabilities, including automated I/O mapping and tag mapping, allow for synchronized system testing, including semi-automated scenarios involving human actions.
2. FAT Testing:
   Facilitates 100% testing of I/O components, ensuring thorough validation of bit logic, patterns, and complex control functions such as PID loops.
   Dramatically reduces the time required for retesting and regression testing, contributing to significant productivity improvements.
3. Commissioning and On-Site Testing:
   The tool allows for automated and semi-automated testing during the commissioning phase, ensuring the system is fully functional when installed on site. Field devices and wiring are tested without the need for manual interventions.
4. Maintenance and Training:
   It can be used to validate system changes during maintenance activities, reducing downtime by ensuring that all changes are thoroughly tested before deployment. Additionally, the tool can simulate various conditions and scenarios for operator training, including criteria for simulations that are graded for a trainee.

In sum, the Test Data Import and Verification Tool is a powerful and flexible solution for testing and verifying PLC logic. By importing test data, using standard communication protocols, and interfacing with the SimSuite system, it automates the process of comparing actual and expected outputs from the SUT. This automation enhances accuracy, reduces errors, and speeds up testing processes, making it a critical tool in the industrial automation sector for validating PLC logic, reducing downtime, and improving overall efficiency in system testing and commissioning.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means plus function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. A system for automated testing of software applications or control systems, comprising:
a simulation hardware, comprising:
a network switch, an industrial controller with discrete inputs and outputs; and cabling for interfacing with a system under test;
a simulation software, operatively connected to the simulation hardware, comprising:
an automapping module configured to automatically query a system under test's tag maps, extract metadata to automatically configure a test environment; and
an in-memory database-unit testing module, comprising input data, expected outputs, and test logic.

2. The system of claim 1, wherein the simulation software is configured to receive a simulation hardware input from a system under test and compare it to an expected output from the in-memory database-unit testing module and determine a pass/fail test status.

3. The system of claim 2, further comprising a breakout board, wherein the breakout board is operationally connected to the simulation hardware and configured to connect to a system under test to enable signal processing or transformations from a system under test to the simulation hardware.

4. The system of claim 2, wherein the expected outputs are spreadsheet-like assertions.

5. The system of claim 2, wherein the expected outputs are bits.

6. The system of claim 2, wherein the discrete inputs and outputs include analog and digital inputs and outputs.

7. The system of claim 2, wherein the expected outputs are extracted from a flowchart-driven automated testing tool (FDATT).

8. The system of claim 7, wherein the FDATT is used for the creation of a software of a system under test.

9. The system of claim 2, wherein the in-memory database-unit testing module, further comprises command operator keywords; and wherein the simulation software is further configured to execute command operations triggered by the command operator keywords.

10. The system of claim 9, wherein a command operation comprises gathering data automatically from a user and determining a command operation pass/fail status.

11. The system of claim 2, further comprising a human-machine interface.

12. A method for automated testing of software applications or control systems, comprising the steps of:
operatively connecting a system under test to a simulation hardware;
operatively connecting the simulation hardware to a simulation software;
automatically querying the system under a test's tag maps, extracting metadata, and configuring a test environment through the simulation software;
receiving a simulation hardware input from the system under test in the simulation software;
comparing the simulation hardware input to an expected output in the simulation software; and
determining a pass/fail test status in the simulation software.

13. The method of claim 12, further comprising the steps of is operationally connecting a breakout board between the simulation hardware and the system under test and enabling signal processing or transformations from the system under test to the simulation hardware.

14. The method of claim 12, wherein the expected output is a spreadsheet-like assertion.

15. The method of claim 12, wherein the expected output are bits.

16. The method of claim 12, further comprising the steps of extracting expected outputs using a flowchart-driven automated testing tool.

17. The method of claim 12, further comprising the steps of executing a command operation triggered by a command operator keyword.

18. The method of claim 17, further comprising the steps of displaying in a human machine interface the command operation triggered by the command operator keyword.

19. The method of claim 18, further comprising the steps of gathering data automatically from a user and determining a command operation pass/fail status.

20. The system of claim 7, wherein the FDATT is configured to:
automatically generate both manual and automated test cases, as well as lifecycle documentation, including Software Requirements Specifications (SRS), Software Design Descriptions (SDD), and Acceptance Test Plans (ATP), from a validated flowchart design;
validate each component in the flowchart design for specific input requirements and metadata, including element IDs and associated actions, prior to generating test cases;
process the validated flowchart design to produce:
manually written test steps based on each path of the flowchart design, incorporating dynamic branch variations and metadata variables;
optionally, automated test cases executable in testing frameworks, including Selenium; and
optionally, system documentation, including figures, tables, and notes, formatted according to predefined templates.
